(19) United States
(12) Patent Application Publication
(10) Pub. No.: US 2006/0047948 A1
(43) Pub. Date: Mar. 2, 2006

(54) Security system for data processing

(75) Inventors: Yi-Hung Shen, Hsin Chu (TW); Chih-Ching Chao, Hsin Chu (TW); Yu-Tsun Hsieh, Hsin Chu (TW)

Correspondence Address: EDWARDS & ANGELL, LLP, P.O. BOX 55874, BOSTON, MA, 02205, US

(73) Assignee: RDC Semiconductor Co., Ltd., Hsin Chu (TW)

(21) Appl. No.: 11/090,751

(22) Filed: Mar. 25, 2005

(30) Foreign Application Priority Data
Aug. 30, 2004 (TW) 093125999

(51) Int. Cl. H04L 9/00

(52) U.S. Cl. 713/153

(57) ABSTRACT

A security system for data processing applied to a data transmission processing architecture is provided, which includes an encoding/decoding module, a processing unit, and a local memory unit. The encoding/decoding module is used to encode transmission data packets to be transmitted, decode received data according to a particular encoding/decoding algorithm and data transfer protocol, and/or perform hash function operations on the encoded/decoded data. The processing unit is coupled to the encoding/decoding module and provides the particular encoding/decoding algorithm and data transfer protocol for the encoding/decoding module to code/decode the data. The local memory unit is coupled to the encoding/decoding module and the processing unit, and provides temporary storage of processing data for the encoding/decoding module and the processing unit. When encoding or decoding data, the processing unit can control the encoding/decoding module according to a variety of encoding/decoding algorithms and data transfer protocols set by a user using software or firmware.

### FIELD OF THE INVENTION

The present invention relates to security systems for data processing, and more particularly, to a security system for data processing applied to a data transmission processing architecture.

### BACKGROUND OF INVENTION

As network communication technology have developed over the years, network communication system is demanded by businesses and institutions of all sizes, from government, large enterprises or schools involving fast and massive data transfer to small offices or studios with relatively smaller data traffic. Also, the maturity of the Internet environment introduces fast information generation and exchange. Hence, having an efficient network environment is becoming the most vital requirement for businesses to keep up with the pace of change.

Regardless of a wireless or wired network communication infrastructure, data transmission speed is usually a major concern to the users. To the contrary, network security is often overlooked. In fact, many companies would rather invest money on improving the network efficiency than the network security. However, individuals and businesses now rely heavily upon network communication for information exchange. Malicious manipulation of information transferred over a network by a third party poses a serious threat on unprotected information, especially confidential information.

In order to prevent third party's active or passive attacks the data traffic on a network, the most common way is to encode the data packets to be transmitted to inhibit unauthorized manipulation. Data packets are transmitted to a receiver via a network communication device, such as a modem, a router, a switch, a gateway, a firewall and/or a wireless access point, which generally employs a particular encoding/decoding algorithm and protocol for encoding/decoding the data packets. The encoding and decoding process can protect the data packets from unauthorized manipulation while the data packets are transferring over the network.

Current network systems are operating with numerous data transfer protocols and algorithms for encoding/decoding data. These protocols may be newly defined or modified based on former ones. At the initial design stage of a network communication device (e.g. a router or a switch as mentioned above), usually the data transfer protocol of this device is chosen. It means the finished product can only be used on a network communication infrastructure with the predefined data transfer protocol. The same applies to the encoding/decoding technique, i.e. the communication device is limited to use the predefined encoding/decoding algorithm. As a result, there is no way but to replace the communication device if a different protocol or encoding/decoding method is to be employed. However, as the users are not able to replace the chip component relating to the data transfer protocol or encoding/decoding algorithm alone, replacement of the entire transmission device is costly.

Therefore, the problem to be solved here is to provide the users with an effective system by which the data transfer protocol and encoding/decoding algorithm can be easily updated and/or replaced.

### SUMMARY OF THE INVENTION

In light of the above drawbacks in the prior art, a primary objective of the present invention is to provide a security system for data processing, which allows users to upgrade or replace settings of data transfer protocols or encoding/decoding algorithms by means of a software or firmware control mechanism.

Another objective of the present invention is to provide a security system for data processing, which can reduce hardware costs required for controlling data transfer protocols and encoding/decoding algorithms by means of a software or firmware control mechanism.

In accordance with the foregoing and other objectives, the present invention proposes a security system for data processing, which is applied to a data transmission processing architecture. The security system comprises: an encoding/decoding module for encoding data packets to be transmitted, decoding received data according to a particular encoding/decoding algorithm and data transfer protocol, and/or performing hash function operations on the encoded/decoded data; a processing unit coupled to the encoding/decoding module and for providing the particular encoding/decoding algorithm and data transfer protocol for the encoding/decoding module to encode/decode the data; and a local memory unit coupled to the encoding/decoding module and the processing unit, and for providing temporary storage of processing data for the encoding/decoding module and the processing unit. When encoding or decoding the data, the processing unit can control the encoding/decoding module according to a variety of encoding/decoding algorithms and data transfer protocols set by a user using software or firmware.

In comparison with the prior art that the encoding/decoding algorithm and data transfer protocol are not changeable, the security system for data processing according to the present invention utilizes a software or firmware control mechanism to allow users to update or replace settings of the encoding/decoding algorithm and data transfer protocol and also reduce hardware costs required for controlling the encoding/decoding algorithm and data transfer protocol.

### BRIEF DESCRIPTION OF THE DRAWINGS

The present invention can be fully understood by reading the following description of the preferred embodiment, with reference made to the accompanying drawing wherein:

FIG. 1 is a schematic block diagram showing a basic architecture of a security system for data processing according to the present invention.

### DETAILED DESCRIPTION OF THE PREFERRED EMBODIMENT

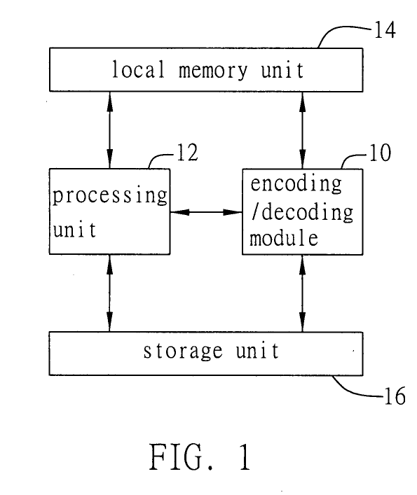

Referring to FIG. 1, it illustrates a basic architecture of a security system for data processing proposed in the present invention. The security system for data processing is applied to for example, but not limited to, a modem. It should noted that the security system for data processing can also be applied to other network communication devices such as a router, switch, gateway, firewall and/or wireless access point, etc. Further, the modem is applied to the Internet for data transfer. As shown in FIG. 1, the security system for data processing in the present invention includes an encoding/decoding module 10, a processing unit 12, and a local memory unit 14.

The encoding/decoding module 10 is used to encode the data packets to be transmitted, decode the received data according to a particular encoding/decoding algorithm and data transfer protocol mode, and/or perform hash function operations on the encoded/decoded data. In this embodiment, when the modem receives data transmitted from a personal computer (a network point) connected thereto, the transmitted data would be packetized into a plurality of data packets to be transmitted according to a network transfer protocol, such that data transmission can be performed in compliance with the network transfer protocol. In this embodiment, the network transfer protocol is the Internet Protocol (IP).

In order to assure the security of the data packets to be transmitted, the encoding/decoding module 10 receives and encodes the data packets to be transmitted to encrypted data according to a particular encoding/decoding algorithm. In this embodiment, according to a Data Encryption Standard (DES) algorithm, the encoding/decoding module 10 encodes the data packets that are to be transmitted via the Internet.

Moreover, when the encoding/decoding module 10 receives data packets sent from any network point via the Internet to the destination of the personal computer, the received data packets are decoded according to the foregoing encoding/decoding algorithm and then subjected to subsequent processing.

The processing module 12 is coupled to the encoding/decoding module 10 and is used to provide the particular encoding/decoding algorithm and data transfer protocol for the encoding/decoding module 10 to encode/decode the data packets. In this embodiment, the processing module 12 provides the modem with required operations, such as data analysis, operational mode control, initial vector control, data flow control etc., based on an instruction set built in the processing module 12. It is to be noted that the processing unit 12 may set up encoding/decoding operational mode control, encoding/decoding data processing, encoding/decoding initial vector control and transfer protocol mode control of the encoding/decoding module 10 based on different encoding/decoding algorithms and data transfer protocols. The processing unit 12 can be a microprocessing unit or a central processing unit.

Furthermore, operation rules of the data transfer protocol or encoding/decoding algorithm for the processing unit 12 can be stored in the form of software or firmware in a storage unit 16 of the modem. The storage unit 16 is substantially a non-volatile and repetitively erasable/writable memory, such as an Electrically Erasable Programmable Read-Only Memory (EEPROM) or a flash memory. Moreover, the operation rules of data transfer protocol or encoding/decoding algorithm stored in the storage unit 16 may be replaced or updated via the personal computer. For instance, in this embodiment, the standard algorithm program for data encoding can be erased and replaced with a rivest-shamir-adleman (RSA) algorithm program.

In regard to the data transfer protocol, various kinds of network transfer protocols are still being developed and evolved, such as IP security protocol (IPsec). After the release of new IPsec, users are able to replace or update the operation rules of data transfer protocol or encoding/decoding algorithm without having to replace hardware components or even the modem.

The local memory unit 14 is coupled to the encoding/decoding module 10 and the processing unit 12, and is used to provide temporary storage of processing data for the encoding/decoding module 10 and the processing unit 12. In this embodiment, the local memory unit 14 can be a volatile memory. Since operation data are required during operations of the encoding/decoding module 10 and the processing unit 12 to generate operation results that allow other units or modules of the modem to perform processing, the local memory unit 14 provides temporary data storage for the encoding/decoding module 10 and the processing unit 12 during data processing.

In conclusion, the security system for data processing in the present invention is capable of utilizing a software or firmware control mechanism to allow users to update or replace settings of the encoding/decoding algorithm and data transfer protocol, and also effectively reducing hardware costs required for controlling the encoding/decoding algorithm and data transfer protocol.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A security system for data processing, which is applicable to a network communication device, the security system comprising:
an encoding/decoding module for encoding transmission data packets to be transmitted, decoding received data according to a particular encoding/decoding algorithm and data transfer protocol, and/or performing hash function operations on the encoded/decoded data;
a processing unit coupled to the encoding/decoding module and for providing the particular encoding/decoding algorithm and data transfer protocol mode for the encoding/decoding module to encode/decode the data;
a storage unit for storing operation rules of the particular encoding/decoding algorithm or data transfer protocol for the processing unit, allowing the operation rules of encoding/decoding algorithm or data transfer protocol stored in the storage unit to be revised or updated via the network communication device; and
a local memory unit coupled to the encoding/decoding module and the processing unit, to provide temporary storage of processing data for the encoding/decoding module and the processing unit.

2. The security system of claim 1, wherein the operation rules of encoding/decoding algorithm or data transfer protocol stored in the storage unit are software or firmware.

3. The security system of claim 1, wherein the storage unit is a non-volatile and repetitively erasable/writable memory.

4. The security system of claim 3, wherein the storage unit is an Electrically Erasable Programmable Read-only Memory (EEPROM) or a flash memory.

5. The security system of claim 4, wherein the operation rules of encoding/decoding algorithm or data transfer protocol stored in the storage unit are software or firmware.

6. The security system of claim 1, wherein the local memory unit is a volatile memory.

7. The security system of claim 1, wherein the processing unit is a microprocessing unit or a central processing unit.

8. The security system of claim 1, wherein the network communication device is selected from the group consisting of a modem, router, switch, gateway, firewall and wireless access point.
